(19) United States
(12) Patent Application Publication
(10) Pub. No.: US 2018/0060440 A1
(43) Pub. Date: Mar. 1, 2018

(54) SYSTEMS AND METHODS TO COGNITIVELY UPDATE STATIC BI MODELS

(71) Applicant: International Business Machines Corporation, Armonk, NY (US)

(72) Inventors: Sonal Bhatt, Chhindwara (IN); Sonia L. Sequeira, PUNE (IN); Hemant K. Sivaswamy, Pune (IN)

(21) Appl. No.: 15/248,334

(22) Filed: Aug. 26, 2016

(51) Int. Cl. G06F 17/30; G06N 5/02

(52) U.S. Cl. CPC G06F 17/30867; G06N 5/02; G06F 17/3053; G06F 17/30554

(57) ABSTRACT

Embodiments of the present invention provide systems and methods for analytics on a set of data. Reports are visualizations of a data model. Because the data model is limited, pre-defined, and structured in typical hierarchies, an end-user can only obtain answers to queries based on data inputted into the data model. When the obtained answers insufficiently respond to the queries, the present invention refines the data model by modifying elements and dimensions of the data model. Thus, the refined data model is able to respond sufficiently to the queries.

### BACKGROUND OF THE INVENTION

The present invention relates generally to the field of data management, and more specifically to obtaining analytics on a set of data.

While modeling data, an end-user (e.g., a modeler) has to assume facts or gather information manually. The system limits the end-user in obtaining in-depth information. The data model is limited, pre-defined, and structured in typical hierarchies, which restricts the end-user from getting any information apart from that in the model or the database. The modeler must include the exact hierarchies while modeling different dimensions in order to obtain results of strategic value. The visual representation of the modeled data may be contained within reports. There are instances of when an end-user analyzes a report and the end-user is unsatisfied with the rendered output in the report. The report, which is based on the hierarchies used to model inputted data, provides insufficient insights into queries. Thus, there is a need to develop a data modeling system with can be efficiently refined to provide more sufficient insights into such queries.

### SUMMARY

According to one embodiment of the present invention, a method for obtaining analytics on a set of data is provided. The method comprises: connecting, by one or more processors, to a cognition system, a knowledge domain and a database; responsive to receiving a query, sending, by one or more processors, instructions to the cognition system to search the connected knowledge domain and the database for a response to the query; determining, by one or more processors, a report to an end-user does not respond to the query, wherein the report is based on a first model, wherein the first model contains a first set of dimensions; and obtaining, by one or more processors, a plurality of answers as the response to the query, based in part on results obtained from searching the connected knowledge domain and the database.

Another embodiment of the present invention provides a computer program product for obtaining analytics on a set of data, based on the method described above.

Another embodiment of the present invention provides a computer system for obtaining analytics on a set of data, based on the method described above.

The methods and systems as disclosed by the embodiments of the present invention may provide the advantages of: (i) a solution which is provided to the modeler or any type of end-user, wherein the solution enables on-the-fly, dynamic refinement of BI models; (ii) a system which is able to answer the questions/queries correctly even if the modeler has not accurately modeled the required dimensions and elements; (iii) not imposing the requirement of all elements of a system to be modeled at the time of creation of a model; (iv) a system which is able to auto-identify and assimilate the data in order to provide meaningful context-specific and domain specific insights to an end-user; (v) a system which can be generically applied to any chart/report specific to any domain; (vi) answers which are specific to the domain in question in order to increase the likelihood of accurately answering questions/queries; (vii) answers which are refined through iterative cognitive learning in order to enhance the robustness of reliability of the system in answering questions/queries; and (viii) a reporting system which contains cognitive capabilities to an end-user or modeler.

### BRIEF DESCRIPTION OF THE DRAWINGS

FIG. 1 is a functional block diagram illustrating a data processing environment, in accordance with an embodiment of the present invention;

FIG. 2 is a flowchart depicting the operational steps as performed by an analytics module, in accordance with an embodiment of the present invention;

FIG. 3 is a functional block diagram illustrating entities mapped upon the implementation of an analytics module on a data set, in accordance with an embodiment of the present invention;

FIG. 4 is a functional block diagram illustrating a set of answers obtained upon the implementation of an analytics module on a query performed on a database, in accordance with an embodiment of the present invention;

FIG. 5 is an example of the altering of data contents within a project viewer interface upon the implementation of an analytics module, in accordance with an embodiment of the present invention;

FIG. 6 is an example of the altering of data contents within a dimension in a project viewer interface upon the implementation of an analytics module, in accordance with an embodiment of the present invention; and

FIG. 7 depicts a block diagram of internal and external components of a computing device, in accordance with an embodiment of the present invention.

### DETAILED DESCRIPTION

A report can be a visualization of a model, which is used to construct the report. The model must include exact hierarchies in order to obtain results of strategic value to an organization. There are instances of reports which are unable to or insufficiently provide answers or insights to queries. The report is a reflection of the hierarchies and data used to generate the model, and in turn, the report. If a report is unable to provide a sufficient response to the queries, then the model needs to be modified. Embodiments of the present invention disclose methods and systems which leverage the power of cognitive learning and external data to process the model and produce more insightful and informative reports. These reports are produced by continuously refining the model used to construct the report. Furthermore, the embodiments of the present invention include: (i) the auto-identification of elements from a dimension; (ii) the processing of the elements and dimensions within charts or other visualizations of a model; and (iii) the incorporation of the relevant domain knowledge in order to complete missing bits in an analysis cycle through iterative cognitive cycles. As the analysis is refined, more relevant and accurate results are available for a wide set of questions.

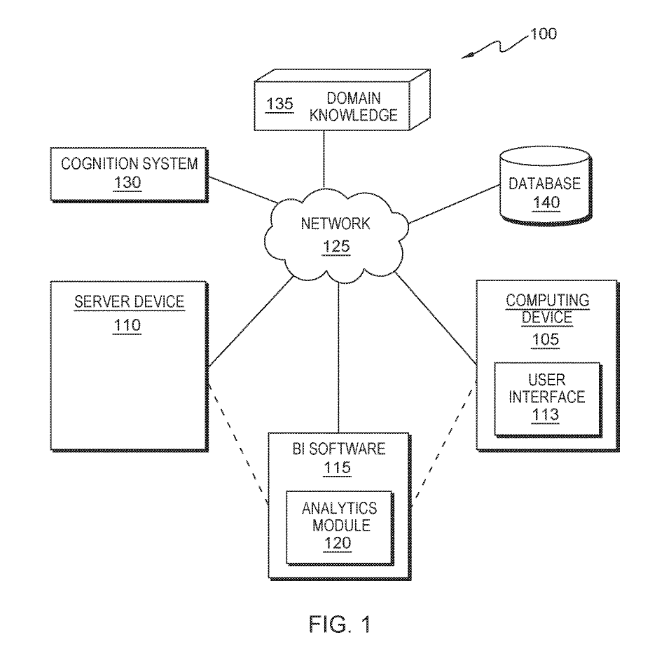

The present invention will now be described in detail with reference to the Figures. FIG. 1 is a functional block diagram illustrating a data processing environment, generally designated 100, in accordance with one embodiment of the present invention. FIG. 1 provides only an illustration of implementation and does not imply any limitations with regard to the environments in which different embodiments may be implemented. Modifications to data processing environment 100 may be made by those skilled in the art without departing from the scope of the invention as recited by the claims. In this exemplary embodiment, data processing environment 100 includes computing device 105, server device 110, cognition system 130, domain knowledge 135, database 140, and BI software 115 which are all interconnected to each other via network 125.

BI software 115 is a type of application software designed to retrieve, analyze, transform, and report data for business intelligence. BI software 115 contains business intelligence tools to read data which has been previously stored in a data warehouse or a data mart. Some categories of business intelligence tools include: spreadsheets (i.e., tools which organize, analyze, and store data in tabular form); reporting and querying software (i.e., tools which extract, sort, summarize, and present selected data); online analytical processing tools (i.e., tools which swiftly answer multi-dimensional analytical queries); digital dashboards (i.e., tools which graphically presents a current status of a system and prior trends in computing usage via snapshots); data mining (i.e., tools which use computational processes to discover the patterns in large data sets); process visualization (i.e., tools which provide real time information about the status and the results of various operations, processes, and transactions); data warehousing (i.e., tools which provide the reporting of data and data analysis by passing data through an operational data store); and local information systems (i.e., an information system designed primarily for support geographic reporting). There are different types/versions of BI software 115 targeted to a specific industry. In one embodiment, BI software 115 resides on computing device 105 and server device 110. In another embodiment, BI software 115 does not reside on computing device 105 or server device 110, and resides on another device. In a preferred embodiment, BI software 115 runs on server device 110. A modeler operates BI software 115 in order to generate a BI model based on the data inputted into BI software 115. An end-user may view the BI model and/or a resulting visualization deriving from the BI model. The BI model is constructed from the modeled dimensions, wherein the dimensions comprise one or more elements.

Analytics module 120 is a patch which is connected to BI software 115. A reporting tool functionality, within analytics module 120, has an option to accept the questions as text/voice commands. Accordingly, analytics module 120 comprehends, interprets the questions, searches the existing data sets (i.e., dimensions and elements) for answers, and performs an action as requested by the end-user (e.g., aggregations and summations). If an answer is not found in the existing sets, analytics module 120 instructs cognition system 130 to examine and search plugged-in domain-specific knowledge bases (i.e., domain knowledge 135 and external database 140). The power of cognitive learning (i.e., the application of cognition system 130) brings in the relevant external information to answer the question/query. The outputted result may be represented in a chart form and/or in text form. Analytics module 120 maps keywords from the knowledge base to the dimensions and the elements used to construct a BI model. As an end-user rates the answers specified by analytics module 120 based on the confidence level, the answers are refined and more aligned with the exact answers the end-user is looking for. Thus, the entire analysis cycle is complete. Minimal or even no manual intervention, input, or thinking is required on the part of the end-user in order to obtain the newly added answers. Subsequently, (i) the end-user is prompted to add/update a dimension every time a new dimension is identified by the cognitive system; and (ii) the process of updating the BI model, is automated. The identification of a new dimension and/or an updated dimension are treated as modifications. These modifications are automatically added to the BI model. This property is configurable as per the user's choice.

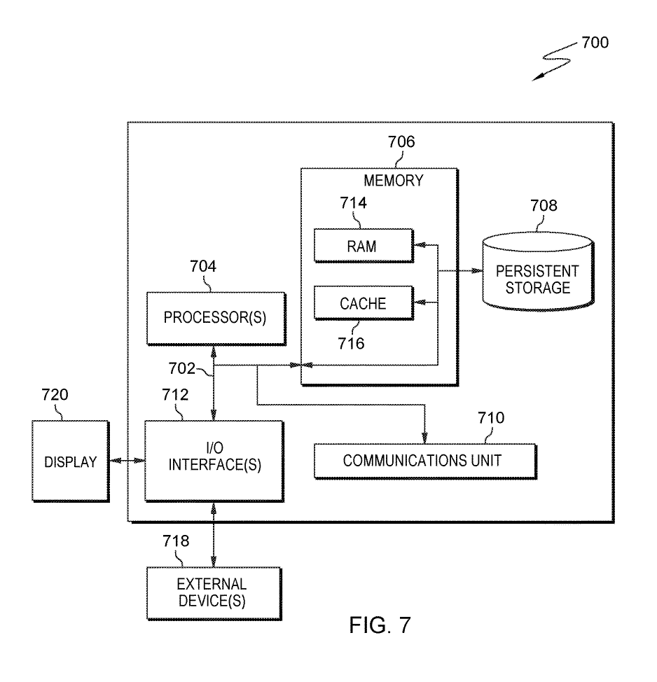

Server device 110 shares data and resources with client devices, such as computing device 105. Server device 110 may take the form of a laptop computer, a tablet computer, a netbook computer, a personal computer (PC), a desktop computer, a personal digital assistant (PDA), a smart phone, a thin client, or any programmable electronic device capable of communicating with BI software 115, computing device 105, cognition system 130, domain knowledge 135, and database 140. Server device 110 may include internal and external hardware components, as depicted and described in further detail with respect to FIG. 7. In one embodiment, server device 110 is a server computer which serves its own computer programs. In other embodiments, server device 110 can be used for application servers (which host web apps); catalog servers (which maintain an index of information); communication servers (which maintain an environment facilitating communication between two or more endpoints); and proxy servers (which act as an intermediary between a client and a server). Server device 110 may provide a different functionality in other scenarios depending on the needs of the end-user of the computing device 105.

Computing device 105 includes user interface 113. Computing device 105 (which is in use by an end-user) may send a question/query, which typically cannot be answered by the existing model, to analytics module 120. Computing device 105 may be a laptop computer, a tablet computer, a netbook computer, a personal computer (PC), a desktop computer, a personal digital assistant (PDA), a smart phone, a thin client, or any programmable electronic device capable of communicating with BI software 115 and network 125. Computing device 105 may include internal and external hardware components, as depicted and described in further detail with respect to FIG. 7.

User interface 113 may be for example, a graphical user interface (GUI) or a web user interface (WUI) and can display text, documents, web browser windows, user options, application interfaces, and instructions for operation, and includes the information (such as graphics, text, and sound) a program presents to a user and the control sequences the user employs to control the program. User interface 113 is capable of receiving data, user commands, and data input modifications from a user and is capable of communicating with BI software 115.

Network 125 may be, for example, a local area network (LAN), a wide area network (WAN) such as the Internet, or a combination of the two, and may include wired, wireless, or fiber optic connections. In general, network 125 can be any combination of connections and protocols that will support communication between computing device 105, server device 110, cognition system 130, domain knowledge 135, database 140, and BI software 115.

Cognition system 130 is a question answering computer system capable of answering questions posed in a natural language (which can take the form of speech, signing, or writing). Natural languages evolve naturally in humans through use and repetition without conscious planning or premeditation, as opposed to constructed and formal languages to program computers or study logic. In other words, natural languages are not a form of computer programming language. For example, cognition system 130 is able to answer a question or query without an end-user or modeler having to apply MACRO instructions or any other type of computer programming technology to obtain an answer. Cognition system 130 works in conjunction with BI software 115 and analytics module 120 to provide an answer to a question and to assist in the modification of previously generated/applied models.

Domain knowledge 135 is valid knowledge used to refer to an area of human endeavor, an autonomous computer activity, or other specialized discipline. Domain knowledge 135 is a target system which operates software agents. Domain knowledge 135 must be learned from software users in the domain as domain specialists/experts, rather than from software developers. The domain may be crucial in the development of a software application. The domain typically refers to text corpus linguistics, wherein corpus linguistics is the study of language as expressed in corpora (i.e., samples) of “real world” text. In embodiments of the present invention, domain is the specialized and specific area, which contains all the information relevant to the specialized and specific area. This information relevant to the specialized and specific area is available to the end-user as a corpus/knowledge base. For example, in instances concerned with copper ore, the domain of domain knowledge 135 is “mining.” Domain knowledge 135 is frequently informal and ill structured, and transformed in computer programs and active data in knowledge bases. Communicating between end-users and software developers is often difficult when there is a lack of a common language. Domain knowledge 135 remedies this situation by providing information/knowledge to end-users. The same information/knowledge may be included in different versions of domain knowledge 135. Knowledge may be applicable across a number of domains. Operations on domain knowledge 135 are performed by meta-knowledge. Domain knowledge 135 works in conjunction with cognition system 130 in order to find an answer to a question/query received by analytics module 120.

Database 140 is an organized collection of data. The collection of data may include schemas, tables, queries, reports, views, and other objects. The data within database 140 is typically organized to model aspects of a situation of interest to a modeler and/or end-user, which supports computing processes requiring information. For example, database 140 contains data which is used to construct a model to investigate the influence of interest rate derivatives on merger and acquisition activity in the global economy.

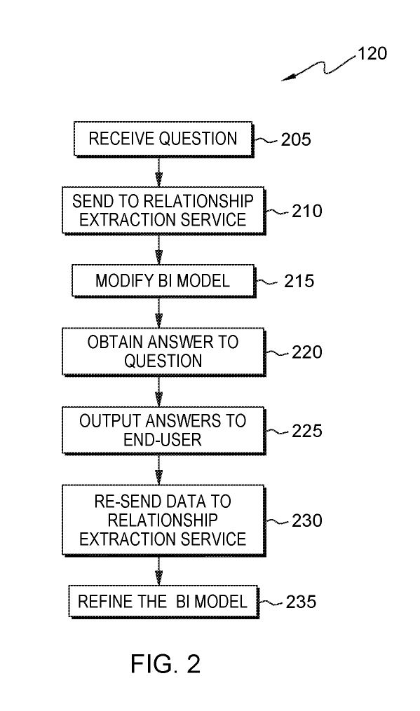

FIG. 2 is a flowchart depicting the operational steps as performed by analytics module 120, in accordance with an embodiment of the present invention.

In step 205, analytics module 120 receives a question. In a preferred embodiment, the end-user of computing device 105 and another party are viewing a visualization in the form of a report. The other party asks the questions which is received by analytics module 120. The report may be a chart, table, or graph which is used to depict findings from an existing model, wherein the reports contain at least one dimension. These dimensions are key performance indicators which are derived from the model. For example, a chart shows copper revenues in different regions of the United States, which is specific to an organization's business units. The different regions in the chart are: the New York region, the Chicago region, and the Denver region. Key performance indicators for this report are: a geographic dimension, wherein the region modeled is the United States; a product dimension, wherein the product modeled is copper; and a measure dimension, wherein the measure is modeled in terms of revenues. Analytics module 120 treats the question as a natural language processing (NLP) query which is parsed to identify possible dimensions. In the example above, the other party asks, “What is the revenue of copper ore sites within 150 mile radius of the Denver office?” Analytics module 120 is able to decipher that “Denver” as posed in the question does not refer to the actual city of Denver but rather the Denver office. Analytics module 120 examines the dimensions in order to find an answer to the question.

In step 210, analytics module 120 sends the results to a relationship extraction service. “Probable entities” are identified as data which corresponds to the dimensions of an existing BI model. Analytics module 120 compares the identified “probable entities” within the existing BI model to identify available dimensions and the elements of the available dimensions. From the example above, revenue and copper are entities further identified as the: “measure” dimension and “product” dimension within the BI model, respectively. The remainder of the “probable entities” are fed into cognition system 130 by analytics module 120 in order to identify possible mappings/identifications for the available dimensions. The question asked is: “What is the revenue of copper ore sites within a 150 mile radius of Denver office?” The “measure” dimension is now identified as “150 miles” and “Denver” is now identified as the “geographic” dimension. The extraction service obtains new dimensions. An end-user or modeler determines whether to add the information contained within the new dimensions.

In step 215, analytics module 120 modifies the BI model. The modification is based on the received question—“What is the revenue of copper ore sites within a 150 mile radius of Denver office?”—in step 205. Prior to modification of the BI model, the BI model was constructed to answer the question/query of, “What is the revenue of copper of all of the regions?” and wherein, the “geography” dimension is “all of the regions”; the “measure” dimension is “revenue”; and the “product” dimension is “copper.” After the modification, analytics module 120 adds “distance” to yield “geography”; “product”; “revenue”; and “distance” as the dimensions of the BI model. Furthermore, “revenue” and “distance” are “measure” dimensions. A “Denver” element is also added to the “geography” dimension of the modified BI model.

In step 220, analytics module 120 obtains an answer to the question. The question/query is fed to cognition system 130, which is pre-fed with domain knowledge 135 and database 140. Cognition system 130 will process “Denver” as being a copper production site as a response to the question—“What is the revenue of copper ore sites within a 150 mile radius of Denver office?” As an answer to the question, cognition system 130 then returns locations of all of the copper production sites within a radius of 150 miles, the relative distance to Denver, and the revenue of the copper production sites with the radius of 150 miles. In this example, the answer to the question is “Region A” which is 50 miles from Denver with a revenue of “X.”

In step 225, analytics module 120 outputs answers to an end-user. For this example, the answer outputted to the end-user is “Region A with a revenue of X.” Typically, these outputted answers are in an unstructured format. A threshold is configured to display the confidence level of the answer and any user feedback. In other embodiments, analytics module 120 may not be able to find a precise answer to the question and outputs one or more potential results as potential answers.

In step 230, analytics module 120 re-sends data to the relationship extraction service. Analytics module 120 modifies the dimensions and elements based on the re-sent data. “Region A” is added as a new element to the geography dimension and the value of “X” is added as a new element to the “measure” dimension (i.e., revenue), assuming the obtained answers derive from domain knowledge 135 and database 140. This answer is based on the question—“What is the revenue of copper within a 150 mile radius of Denver?” This step is described in further detail with respect to the discussion to FIG. 6.

In step 235, analytics module 120 refines the BI model. In this example, the BI model is fed with new data, wherein the new data is “distance” as a new measure dimension and “A” as a new region (i.e., a new element) with the “geography” dimension. An end-user, modeler, and/or third party asks whether or not to add the new region and the new dimension to the BI model. Once confirmed by the end-user, modeler, and/or third party, the new data is added to the BI model and the BI model is able to grow dynamically. Over a period time, the obtained data and inputted data into the BI model keeps getting refined. Based on the questions/queries from a third party, the BI model may also be dynamically improved by refining the data used to construct the BI model.

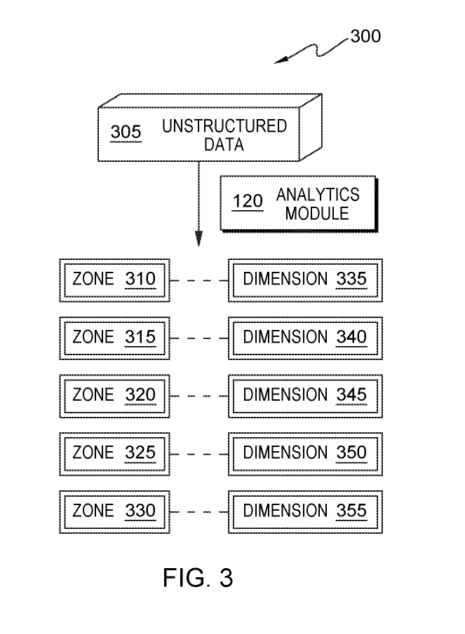

FIG. 3 is a functional block diagram illustrating entities mapped upon the implementation of analytics module 120 on a data set, in accordance with an embodiment of the present invention.

In environment 300, analytics module 120 receives a question regarding a visualization of data which has been modeled. In order to find an answer, analytics module 120 instructs cognition system 130 to parse through data/information found in domain knowledge 135 and database 140 (as described in FIG. 2). When trying to answer the question as received by analytics module 120, data is obtained which may be an answer (or answers) to the question in the form of unstructured data 305. A “relationship extraction service” functionality of analytics module 120 maps different entities in unstructured data 305 as a zone to a dimension (i.e., a category to describe a zone).

Unstructured data 305 is mapped as zone 310, zone 315, zone 320, zone 325 and zone 330 which correspond to dimension 335, dimension 340, dimension 345, dimension 350, and dimension 355, respectively. Unstructured data 305 derives from a source, such as an article. For example, unstructured data 305 deriving from an article contains the following content: “The 1906 Chicago Cubs and 2001 Seattle Mariners are the only teams to win 116 games in the regular season.” Zone 310 contains “1906 Chicago Cubs”; zone 315 contains “2001 Seattle Mariners”; zone 320 contains “teams”; zone 325 contains “win 116 games”; and zone 330 contains “regular season.” Dimension 335, dimension 340, and dimension 345 are assigned to the category “team” and wherein, zone 310, zone 315, and zone 320 are associated with dimension 335, dimension 340, and dimension 345, respectively. Dimension 350 is assigned to the category “team record” and wherein, zone 325 is associated with dimension 350. Dimension 355 is assigned to the category “duration” and wherein, zone 330 is associated with dimension 355.

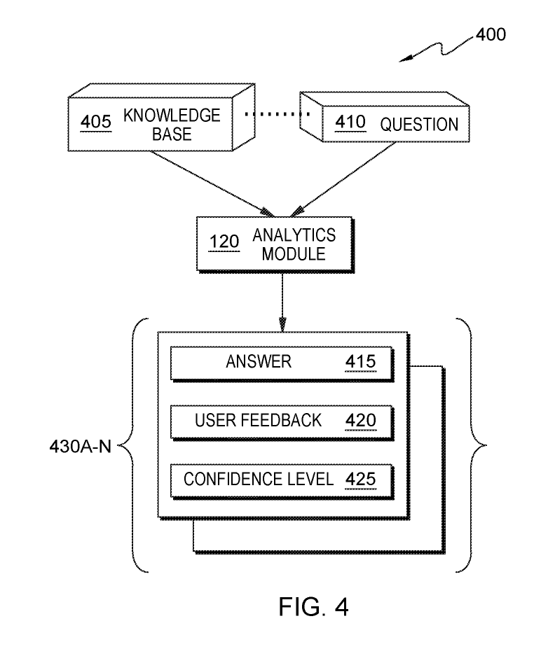

FIG. 4 is a functional block diagram illustrating a set of answers obtained upon the implementation of analytics module 120 on a query performed on a database, in accordance with an embodiment of the present invention.

In environment 400, analytics module 120 receives question 410. Knowledge base 405 (i.e., databases such as database 140 and domain knowledge 135) are parsed by cognition system 130 in order to answer question 410. Analytics module 120 takes the resulting data from question 410 posed on knowledge base 405, which yields outputs 430A-N. Each unit among outputs 430A-N contain answer 415 (i.e., the actual content of the resulting data from question 410 posed on knowledge base 405); user feedback 420 (i.e., an option for an end-user to indicate whether answer 415 is relevant, partially relevant, or not relevant); and confidence level 425 (i.e., a percentage which is indicative of the perceived accuracy of answer 415).

In an exemplary embodiment, question 410 is “How high is Mount Everest?” Knowledge base 405 is Corpus: Travel. There are three outputted units among outputs 430A-N.

A first outputted unit among outputs 430A-N contains: “Mount Everest is the world's tallest mountain at 29,029 ft (8,848 m). It straddles the border of China and Nepal and can be visited from either side: Khumbu (Sagarmatha National Park), the more commonly visited region on the Nepalese (southern) side of the mountain. Qomolangma, the less visited nature reserve on the Tibetan (northern) side.” In answer 415; hyperlinks “Yes”, “No”, and “Partial” which can be accessed by an end-user in user feedback 420; and “Confidence: 15%” in confidence level 425.

A second outputted unit among outputs 430A-N contains: “A deadly Apr. 13, 2014 avalanche at the Khumbu Icefall, a rapidly-shifting glacier on the southern ascent to Everest, buried sixteen Sherpa guides; three of the sixteen bodies were not recovered. [1] As Sherpa increasingly leave the base camp in protest of dangerous conditions and poor remuneration, many 2014 expeditions have been cancelled. [2] Mount Everest is the highest mountain in the world. Its height is 8,848 meters (29,028 ft). Its alternate names are Qomolangma, Sagarmatha, and Chomolungma. Mount Everest lies on the border of Nepal and China, with about half of the mountain lying on each side of the border. Sir Edmund Hillary and Tenzing Norgay first climbed it in 1953, with Hillary taking the famous photograph of Tenzing Norgay in the summit.” In answer 415; hyperlinks “Yes”, “No”, and “Partial” which can be accessed by an end-user in user feedback 420; and “Confidence: 7%” in confidence level 425.

A third outputted unit of outputs 430A-N contains: “NOTE: A deadly Apr. 13, 2014 avalanche at the Khumbu Icefall, a rapidly-shifting glacier on the southern ascent to Everest, buried sixteen Sherpa guides; three of the sixteen bodies were not recovered. [1] As Sherpa increasingly leave the base camp in protest of dangerous conditions and poor remuneration, many 2014 expeditions have been cancelled. [2]. Mount Everest is the highest mountain in the world. Its height is 8,848 meters (29,028 ft). Its alternate names are Qomolangma, Sagarmatha, and Chomolungma. Mount Everest lies on the border of Nepal and China, with about half of the mountain lying on each side of the border.” in answer 415; hyperlinks “Yes”, “No”, and “Partial” which can be accessed by an end-user in user feedback 420; and “Confidence: 6%” in confidence level 425.

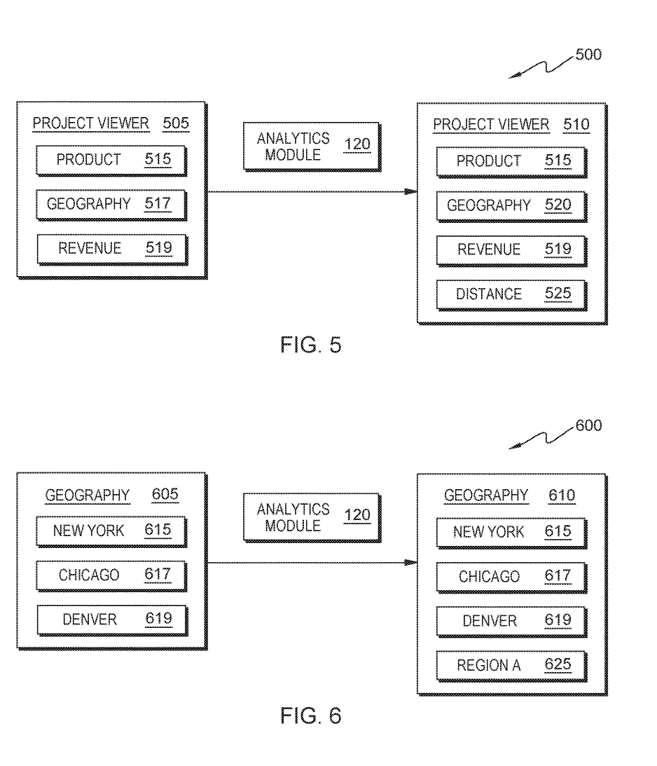

FIG. 5 is an example of altering of data contents within a project viewer interface upon the implementation of analytics module 120, in accordance with an embodiment of the present invention.

In environment 500, analytics module 120 receives a question, “What is the revenue of copper ore sites within a 150 mile radius of Denver office?” Project viewer 505 and project viewer 510 contain dimensions modeled to evaluate key performance indicators. Prior to receiving the question, project viewer 505 contains dimension 515, which is a product dimension; dimension 517, which is a geography dimension; and dimension 519, which is a revenue dimension. After receiving the question, project viewer 510 contains dimension 515, which is a product dimension; dimension 520, which is a geography dimension; dimension 519, which is a revenue dimension; and dimension 525, which is a distance dimension. Dimension 519 and dimension 525 are measure dimensions. In order to answer the question—“What is the revenue of copper ore sites within a 150 mile radius of Denver office?”—product 515 and revenue 519 in project viewer 510 are the same as product 515 and revenue 519 in project viewer 505. In other words, the product and revenue dimensions are unchanged from project viewer 505 and project viewer 510. Project viewer 505 does not contain “Denver” as an element within dimension 517, which is a geography dimension. In contrast, after receiving the question—“What is the revenue of copper ore sites within a 150 mile radius of Denver office?”—Dimension 520 contains the element “Denver” within dimension 520. Dimension 520 is a modified geography dimension in comparison to dimension 517. Dimension 525 is added to model the key performance indicator in project viewer 510 as a way to answer the “150 miles radius” portion of the question, wherein dimension 525 is a distance dimension.

FIG. 6 is an example of the altering of data contents within a dimension in a project viewer interface upon the implementation of analytics module 120, in accordance with an embodiment of the present invention.

In environment 600, analytics module 120 answers the question, “What is the revenue of copper ore sites within a 150 mile radius of Denver office?” Geography 605 and geography 610 are geography dimensions prior to answering the question and after answering the question, respectively. Prior to answering the question, geography 605 contains element 615, which is the “New York” region; element 617, which is the “Chicago” region; and element 619, which is the “Denver” region. After answering the question, geography 610 contains element 615, which is the “New York” region; element 617, which is the “Chicago” region; element 619, which is the “Denver” region; and element 625, which is “Region A.” After answering the question, element 615; element 617; and element 619 in geography 605 are the same as element 615; element 617; and element 619 in geography 610. In other words, the “New York” region, “Chicago” region, and “Denver” region are unchanged from geography 605 and geography 610. Geography 610 does not contain “Region A” as an element. In contrast, after answering the question, element 625 is added to answer the question, wherein “Region A” is element 625.

FIG. 7 depicts a block diagram of components of a computing device, generally designated 700, in accordance with an illustrative embodiment of the present invention. It should be appreciated that FIG. 7 provides only an illustration of one implementation and does not imply any limitations with regard to the environments in which different embodiments may be implemented. Many modifications to the depicted environment may be made.

Computing device 700 includes communications fabric 702, which provides communications between computer processor(s) 704, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer readable storage media. In this embodiment, memory 706 includes random access memory (RAM) 714 and cache memory 716. In general, memory 706 can include any suitable volatile or non-volatile computer readable storage media.

Program instructions and data used to practice embodiments of the present invention may be stored in persistent storage 708 for execution and/or access by one or more of the respective computer processors 704 via one or more memories of memory 706. In this embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 710, in these examples, provides for communications with other data processing systems or devices. In these examples, communications unit 710 includes one or more network interface cards. Communications unit 710 may provide communications through the use of either or both physical and wireless communications links. Program instructions and data used to practice embodiments of the present invention may be downloaded to persistent storage 708 through communications unit 710.

I/O interface(s) 712 allows for input and output of data with other devices that may be connected to computing device 700. For example, I/O interface 712 may provide a connection to external devices 718 such as a keyboard, keypad, a touch screen, and/or some other suitable input device. External devices 718 can also include portable computer readable storage media such as, for example, thumb drives, portable optical or magnetic disks, and memory cards. Software and data used to practice embodiments of the present invention, e.g., software and data, can be stored on such portable computer readable storage media and can be loaded onto persistent storage 708 via I/O interface(s) 712. I/O interface(s) 712 also connect to a display 720.

Display 720 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience and thus, the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-7. (canceled)

8. A computer program product for obtaining analytics on a set of data, comprising:
a computer readable storage medium and program instructions stored on the computer readable storage medium, the program instructions comprising:
program instructions to connect to a cognition system, a knowledge domain and a database;
responsive to receiving a query, program instructions to send instructions to the cognition system to search the connected knowledge domain and the database for a response to the query;
program instructions to determine a report to an end-user does not respond to the query, wherein the report is based on a first model, wherein the first model contains a first set of dimensions; and
program instructions to obtain a plurality of answers as the response to the query, based in part on results obtained from searching the connected knowledge domain and the database.

9. The computer program product of claim 8, wherein program instructions to determine the report to the end-user does not respond to the query, further comprise:
program instructions to determine which elements of the first set of dimensions respond to the query; and
program instructions to determine which elements of the first set of dimensions do not respond to the query.

10. The computer program product of claim 8, wherein program instructions to send the instructions to the cognition system to search the connected knowledge domain and the database, further comprise:
program instructions to identify a plurality of data which corresponds to the first set of dimensions, wherein the plurality of data derives from the results obtained from searching the connected knowledge domain and the database; and
program instructions to modify at least part of the first set of dimensions based on the query.

11. The computer program product of claim 10, wherein program instructions to modify at least part of the first set of dimensions, comprise:
program instructions to create a second set of dimensions, comprising:
program instructions to add one or more dimensions to the first set of dimensions; and
program instructions to modify elements, which are contained within the first set of dimensions.

12. The computer program product of claim 11, further comprises:
program instructions to associate elements of the results obtained from searching the connected knowledge domain and the database, with one or more dimensions within the second set of dimensions; and
program instructions to output the results obtained as the plurality of answers to the end-user.

13. The computer program product of claim 12, wherein program instructions to output the plurality of answers, comprise:
program instructions to output contents of the plurality of answers;
program instructions to output to an interface, feedback from the end-user on a level of relevance of the outputted plurality of answers; and
program instructions to output a value with contents of the plurality of answers, wherein the value is indicative of a confidence level of the level of relevance of the plurality of answers.

14. The computer program product of claim 13, further comprises:
program instructions to send the plurality of answers into the knowledge domain and the database in order to further refine a first model; and
program instructions to create new models based on the refined first model.

15. A computer system for analytics on a set of data, comprising:
one or more computer processors;
one or more computer readable storage media; and
program instructions stored on the one or more computer readable storage media for execution by at least one of the one or more processors, the program instructions comprising:
program instructions to connect to a cognition system, a knowledge domain and a database;
responsive to receiving a query, program instructions to send instructions to the cognition system to search the connected knowledge domain and the database for a response to the query;
program instructions to determine a report to an end-user does not respond to the query, wherein the report is based on a first model, wherein the first model contains a first set of dimensions; and
program instructions to obtain a plurality of answers as the response to the query, based in part on results obtained from searching the connected knowledge domain and the database.

16. The computer system of claim 15, wherein program instructions to determine the report to the end-user does not respond to the query, further comprise:
program instructions to determine which elements of the first set of dimensions respond to the query; and
program instructions to determine which elements of the first set of dimensions do not respond to the query.

17. The computer system of claim 15, wherein program instructions to send the instructions to the cognition system to search the connected knowledge domain and the database, further comprise:
program instructions to identify a plurality of data which corresponds to the first set of dimensions, wherein the plurality of data derives from the results obtained from searching the connected knowledge domain and the database; and
program instructions to modify at least part of the first set of dimensions based on the query.

18. The computer system of claim 17, wherein program instructions to modify at least part of the first set of dimensions, comprise:
program instructions to create a second set of dimensions, comprising:
program instructions to add one or more dimensions to the first set of dimensions; and
program instructions to modify elements, which are contained within the first set of dimensions.

19. The computer system of claim 18, further comprises:
program instructions to associate elements of the results obtained from searching the connected knowledge domain and the database, with one or more dimensions within the second set of dimensions; and
program instructions to output the results obtained as the plurality of answers to the end-user.

20. The computer system of claim 19, wherein program instructions to output the plurality of answers, comprise:
program instructions to output contents of the plurality of answers;
program instructions to output to an interface, feedback from the end-user on a level of relevance of the outputted plurality of answers; and
program instructions to output a value with contents of the plurality of answers, wherein the value is indicative of a confidence level of the level of relevance of the plurality of answers.

21. The computer system of claim 20, further comprises:
program instructions to send the plurality of answers into the knowledge domain and the database in order to further refine a first model; and
program instructions to create new models based on the refined first model.
